(19) United States
(12) Patent Application Publication
(10) Pub. No.: US 2024/0286255 A1
(43) Pub. Date: Aug. 29, 2024

(54) FASTENER STRIP

(71) Applicant: Black & Decker Inc., New Britain, CT (US)

(72) Inventors: Jack Dunning, White Plains, NY (US); Wesson Charles, Rosedale, MD (US); Ross A. Billings, Reisterstown, MD (US); Mark Serokosz, New Fairfield, CT (US)

(21) Appl. No.: 18/584,396

(22) Filed: Feb. 22, 2024

Related U.S. Application Data
(60) Provisional application No. 63/486,690, filed on Feb. 24, 2023.

(51) Int. Cl. B25B 23/04; B25C 1/00

(52) U.S. Cl. CPC B25B 23/045; B25C 1/003

(57) ABSTRACT

A strip for holding fasteners includes a backer extending along a strip axis and having a first side and a second side, wherein the second side is opposite the first side. The strip includes fastener holders disposed along a length of the first side of the backer, where each of the fastener holders includes a first loop having a first hole and a second loop having a second hole configured to hold a fastener. The backer is configured to be fed through a magazine of a power tool such that fasteners held by the fastener holders may be driven into a workpiece by the power tool.

### RELATED APPLICATION

This application claims priority, under 35 U.S.C. § 119(e), to U.S. Provisional Application No. 63/486,690, filed Feb. 24, 2023, titled “Fastener Strip,” which is incorporated by reference.

### TECHNICAL FIELD

This description relates to a fastener (e.g., screw or nail) strip for use with a power tool (e.g., screwgun, drywall screwgun, screwdriver, drill/driver, or nailer).

### BACKGROUND

A power tool, such as a screwgun, drywall screwgun, screwdriver, drill/driver, or nailer, may be used to drive fasteners, such as screws or nails, into a workpiece.

### SUMMARY

In one general aspect, the techniques described herein relate to a strip for holding fasteners, including: a backer extending along a strip axis and having a first side and a second side, the second side being opposite the first side; and a plurality of fastener holders disposed along a length of the first side of the backer, where each of the plurality of fastener holders includes a first loop having a first hole and a second loop having a second hole configured to hold a fastener, where the backer is configured to be fed through a magazine of a power tool such that a plurality of fasteners held by the plurality of fastener holders may be driven into a workpiece by the power tool.

Implementations may include one or more of the following features.

In some aspects, the techniques described herein relate to a strip, where the plurality of fasteners are disposed within at least a subset of the plurality of fastener holders, where each of the plurality of fasteners is disposed within one of the subset of the plurality of fastener holders.

In some aspects, the techniques described herein relate to a strip, where each of the plurality of fasteners includes a head and a shank coupled to the head.

In some aspects, the techniques described herein relate to a strip, where the shank of each of the plurality of fasteners is disposed within the first loop and the second loop of one of the subset of the plurality of fastener holders.

In some aspects, the techniques described herein relate to a strip, where the head of a first fastener of the plurality of fasteners overlaps the head of a second fastener of the plurality of fasteners.

In some aspects, the techniques described herein relate to a strip, where each of the plurality of fasteners includes a screw.

In some aspects, the techniques described herein relate to a strip, further including a projection along an edge of a length of the second side of the backer.

In some aspects, the techniques described herein relate to a strip, where the projection includes a plurality of teeth along a length of the projection.

In some aspects, the techniques described herein relate to a strip, where the backer includes a plurality of recesses disposed along the length of the backer with each of the plurality of recesses aligned with one of the plurality of fastener holders, where the plurality of recesses are configured to be engaged by a pawl of the power tool as the backer is fed through the magazine.

In some aspects, the techniques described herein relate to a strip, where each of the plurality of recesses has a parallelogram shape.

In some aspects, the techniques described herein relate to a strip, where each of the plurality of recesses has a rectangular shape.

In some aspects, the techniques described herein relate to a strip, further including a terminal support disposed between one end of the backer and an end recess of the plurality of recesses.

In some aspects, the techniques described herein relate to a strip, where the terminal support includes a terminal recess configured to be engaged by a pawl when the fastener in a last one of the plurality of fastener holders is being driven by the power tool.

In some aspects, the techniques described herein relate to a strip, where the terminal support further includes a terminal protrusion that projects from the first side of the backer adjacent the terminal recess.

In some aspects, the techniques described herein relate to a strip, where the terminal support includes a first terminal support and a second terminal support.

In some aspects, the techniques described herein relate to a strip, where each of the plurality of fasteners is received in each of the first loop and the second loop of the plurality of fastener holders along a fastener axis that is transverse to the strip axis.

In some aspects, the techniques described herein relate to a strip, where the fastener axis is at an acute angle to the strip axis.

In some aspects, the techniques described herein relate to a strip, where the backer includes a plurality of recesses disposed along the length of the backer with each of the plurality of recesses extending along the fastener axis.

In some aspects, the techniques described herein relate to a strip, where the first hole and the second hole each includes a through hole.

In some aspects, the techniques described herein relate to a strip, where the first hole and the second hole each includes a partial hole, a blind hole, a recess, or a score.

In another general aspect, the techniques described herein relate to a strip for holding fasteners, including: a backer extending along a strip axis and having a first side and a second side, the second side being opposite the first side; a plurality of fastener holders disposed along a length of the first side of the backer; and a terminal support that projects from the first side of the backer disposed between one end of the backer and an end fastener holder from the plurality of fastener holders.

Implementations may include one or more of the following features.

In some aspects, the techniques described herein relate to a strip, where the terminal support includes a first terminal support and a second terminal support.

In some aspects, the techniques described herein relate to a strip, where the terminal support includes a terminal recess configured to be engaged by a pawl when a fastener in a last one of the plurality of fastener holders is being driven by a power tool.

In some aspects, the techniques described herein relate to a strip, where the terminal support further includes a terminal protrusion that projects from the first side of the backer adjacent the terminal recess.

In some aspects, the techniques described herein relate to a strip, where each of the plurality of fastener holders includes a first loop and a second loop.

In some aspects, the techniques described herein relate to a strip, further including a plurality of fasteners disposed within at least a subset of the plurality of fastener holders, where each of the plurality of fasteners is disposed within one of the subset of the plurality of fastener holders.

In some aspects, the techniques described herein relate to a strip, further including a projection along an edge of a length of the second side of the backer.

In some aspects, the techniques described herein relate to a strip, where the projection includes a plurality of teeth along a length of the projection.

In some aspects, the techniques described herein relate to a strip, where the backer includes a plurality of recesses disposed along the length of the backer with each of the plurality of recesses aligned with one of the plurality of fastener holders, where the plurality of recesses are configured to be engaged by a pawl of a power tool as the backer is fed through a magazine of the power tool.

In some aspects, the techniques described herein relate to a strip, where each of the plurality of recesses has a parallelogram shape.

In some aspects, the techniques described herein relate to a strip, where each of the plurality of recesses has a rectangular shape.

In some aspects, the techniques described herein relate to a strip, where each of the fasteners is received in each of the first loop and the second loop of the plurality of fastener holders along a fastener axis that is transverse to the strip axis.

In some aspects, the techniques described herein relate to a strip, where the fastener axis is at an acute angle to the strip axis.

In some aspects, the techniques described herein relate to a strip, where the backer includes a plurality of recesses disposed along the length of the backer with each of the plurality of recesses extending along the fastener axis.

In some aspects, the techniques described herein relate to a strip, where each of the fasteners includes a head and a shank coupled to the head.

In some aspects, the techniques described herein relate to a strip, where the shank of each of the fasteners is disposed with the first loop and the second loop of one of a subset of the plurality of fastener holders.

In some aspects, the techniques described herein relate to a strip, where the head of a first fastener of the fasteners overlaps the head of a second fastener of the fasteners.

In some aspects, the techniques described herein relate to a strip, where each of the fasteners includes a screw.

In another general aspect, the techniques described herein relate to a method of manufacturing a fastener strip, the method including: injecting molten plastic into a mold cavity of a mold for a fastener strip, the mold configured to form the fastener strip including a backer extending along a strip axis and having a first side and a second side, the second side being opposite the first side, a plurality of fastener holders disposed along a length of the first side of the backer, where each of the plurality of fastener holders includes a first loop and a second loop, and a first hole in the first loop and second hole in the second loop of each of the plurality of fastener holders; releasing the fastener strip from the mold; and inserting a fastener through the first loop and the second loop of each of the plurality of fastener holders.

Implementations may include one or more of the following features.

In some aspects, the techniques described herein relate to a method, where the first hole and the second hole of each of the plurality of fastener holders are formed by mold core pins received in the mold cavity.

In some aspects, the techniques described herein relate to a method, where the fastener in each of the plurality of fastener holders includes a head and a shank coupled to the head.

In some aspects, the techniques described herein relate to a method, where the shank is disposed within the first loop and the second loop of one of a subset of the plurality of fastener holders.

In some aspects, the techniques described herein relate to a method, where the head of a first fastener overlaps the head of a second fastener.

In some aspects, the techniques described herein relate to a method, where the fastener in each of the plurality of fastener holders includes a screw.

In some aspects, the techniques described herein relate to a method, where the fastener strip further includes a projection along an edge of a length of the second side of the backer.

In some aspects, the techniques described herein relate to a method, where the projection includes a plurality of teeth along a length of the projection.

In some aspects, the techniques described herein relate to a method, where the backer includes a plurality of recesses disposed along the length of the backer with each of the plurality of recesses aligned with one of the plurality of fastener holders, where the plurality of recesses are configured to be engaged by a pawl of a power tool as the backer is fed through a magazine.

In some aspects, the techniques described herein relate to a method, where each of the plurality of recesses has a parallelogram shape.

In some aspects, the techniques described herein relate to a method, where each of the plurality of recesses has a rectangular shape.

In some aspects, the techniques described herein relate to a method, where the fastener strip further includes a terminal support disposed between one end of the backer and an end recess of the plurality of recesses.

In some aspects, the techniques described herein relate to a method, where the terminal support includes a terminal recess configured to be engaged by a pawl when the fastener in a last one of the plurality of fastener holders is being driven by the power tool.

In some aspects, the techniques described herein relate to a method, where the terminal support further includes a terminal protrusion that projects from the first side of the backer adjacent the terminal recess.

In some aspects, the techniques described herein relate to a method, where the terminal support includes a first terminal support and a second terminal support.

In some aspects, the techniques described herein relate to a method, where the fastener is received in the first loop and the second loop in each of the plurality of fastener holders along a fastener axis that is transverse to the strip axis.

In some aspects, the techniques described herein relate to a method, where the fastener axis is at an acute angle to the strip axis.

In some aspects, the techniques described herein relate to a method, where the backer includes a plurality of recesses disposed along the length of the backer with each of the plurality of recesses extending along the fastener axis.

In some aspects, the techniques described herein relate to a method, where the first hole and the second hole each includes a through hole.

In some aspects, the techniques described herein relate to a method, where the first hole and the second hole each includes a partial hole, a blind hole, a recess, or a score.

The details of one or more implementations are set forth in the accompanying drawings and the description below. Other features will be apparent from the description and drawings, and from the claims.

### BRIEF DESCRIPTION OF THE DRAWINGS

FIG. 1 is side view of an example screwgun.

FIG. 2 is a side view of an example magazine and feeding and advancing mechanism of the screwgun of FIG. 1.

FIG. 3 is a partial cutaway, side view of the magazine and the feeding and advancing mechanism of the screwgun of FIG. 1.

FIG. 4 is a perspective view of an example fastener strip.

FIG. 5A is a perspective view of the fastener strip of FIG. 4 with fasteners.

FIG. 5B is a close-up perspective view of an end portion of the fastener strip of FIG. 4 with fasteners.

FIG. 6 is a bottom view of the fastener strip of FIG. 4.

FIG. 7 is a bottom view of the fastener strip of FIG. 4 with fasteners.

FIG. 8 is a partial, detailed perspective view of the fastener strip of FIG. 4.

FIG. 9 is a view of another example fastener strip illustrating fasteners before being driven.

FIG. 10 is a detailed view of the fastener strip of FIG. 9 illustrating a position of a fastener as the fastener is being driven.

FIG. 11 is a detailed view of the fastener strip of FIGS. 9 and 10 illustrating the position of the fastener of FIG. 10 after the fastener has been driven.

FIG. 12 is a rear, perspective view of another example fastener strip with fasteners.

FIG. 13A-13G illustrate an example process for manufacturing a fastener strip.

FIG. 14 is an example flow diagram of an process for manufacturing a fastener strip.

### DETAILED DESCRIPTION

This document describes a fastener strip for use with a power tool, such as a screwgun, drywall screwgun, screwdriver, drill/driver, or nailer to drive fasteners, such as screws or nails, into a workpiece. In one example, the fastener strip is a screw strip for use with a screwdriver, such as a screwgun or a drywall screwgun. The fastener strip is a strip of multiple fasteners, such as screws, that is fed into a magazine of the power tool. A feeding and advancing mechanism feeds and advances the fastener strip in the power tool as the fasteners are driven by a fastener driving bit into a workpiece. The fastener strip includes a backer having multiple fastener holders disposed along a length of the backer. The backer may be a rigid or a semi-rigid structure that maintains its rigidity as the fastener strip is fed through the feeding and advancing mechanism. In other words, the backer is not flimsy and is resistant to being bent as the fastener strip is fed through the feeding and advancing mechanism.

This document further describes that each of the fastener holders includes one or more (e.g., a pair) of loops with each loop having a hole or thinner or weaker portion. The pair of loops holds the fastener in place against the backer. As a fastener is driven by the power tool bit into a workpiece, the fastener breaks free from the pair of loops due to the hole in each loop. The fastener strip also includes a terminal support that projects from the backer, where the terminal support assists in retaining the fastener strip within the feeding and advancing mechanism as the feeding and advancing mechanism advances the fastener strip.

This document also describes that the fastener strip is manufactured using a molding process. After the fastener strip is molded, then the fasteners are inserted into the fastener strip.

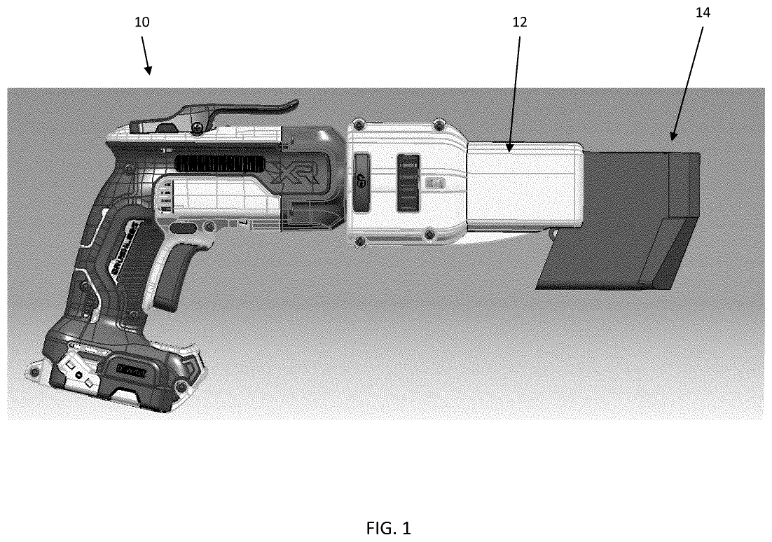

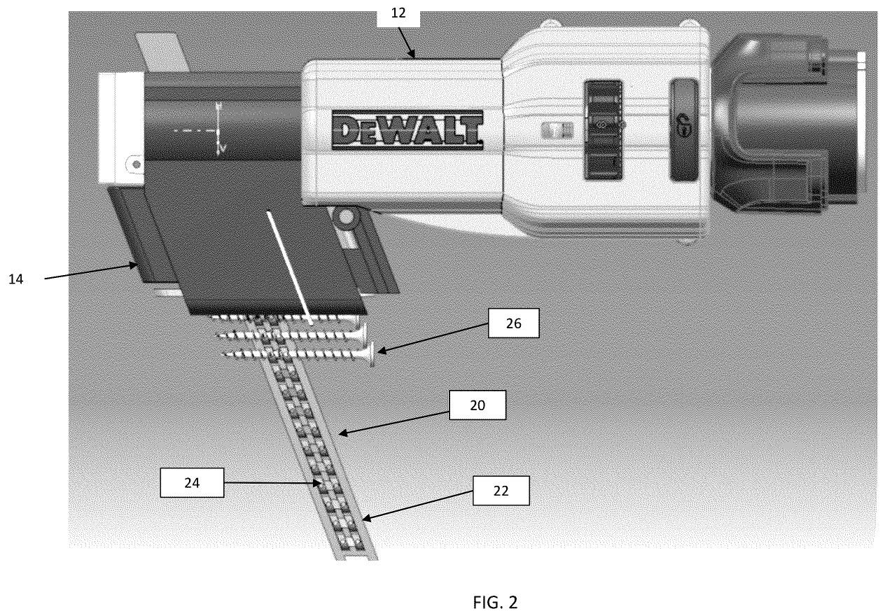

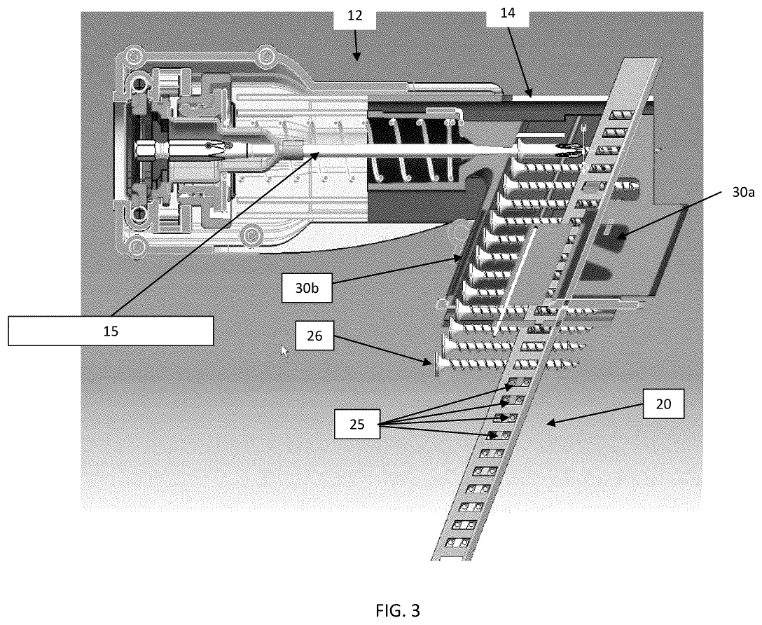

FIG. 1 illustrates a side view of an exemplary power tool in the form of a screwgun 10. The screwgun 10 includes a magazine 12 (which may be integral with or removable from the screwgun) with a feeding and advancing mechanism 14. FIG. 2 illustrates a side view of the magazine 12 and the feeding and advancing mechanism 14 of the screwgun 10 of FIG. 1 and FIG. 3 illustrates a partial cutaway, side view of the magazine 12 and the feeding and advancing mechanism 14 of the screwgun 10 of FIG. 1.

The screwgun 10 is one example of a power tool that is configured to drive a fastener, such as a screw, drywall screw or other types of screws, into a workpiece. Other power tools may be configured to drive a fastener, such as a nail, a bolt, an anchor, a rivet, or the like, into a workpiece. In this example, the magazine 12 is configured to be removably and rotatably attachable to the screwgun 10. The feeding and advancing mechanism 14 is received in the magazine 12. The feeding and advancing mechanism 14 is configured to receive and advance a fastener strip 20 into position to be driven by a screwdriving bit 15, as best seen in FIGS. 2 and 3.

The fastener strip 20 includes a backer 22, fastener holders 24 disposed on one side of the backer 22, and fasteners 26 held by the fastener holders 24 against the backer 22. On the other side of the backer are recesses 25. In some examples, a fastener holder 24 is on one side of the backer 22 and a recess 25 is opposite each of the fastener holders 24 on the other side of the backer 22. In some examples, the recesses 25 are through holes or apertures. In other examples, the recesses 25 may not be through holes apertures that penetrate completely from one side of the backer 22 through to the other side of the backer 22.

The fastener strip 20 is a strip of collated fasteners 26 that is fed into the feeding and advancing mechanism 14 so that the fasteners 26 held by the fastener holders 24 may be driven into a workpiece by the screwdriving bit 15. In one example, the feeding and advancing mechanism 14 include pawls 30a and 30b that function like leaf springs to grab and advance the fastener strip 20. The pawls 30a and 30b use the recesses 25 on the backer 22 to feed and advance the fastener strip 20. Examples of feeding and advancing mechanisms also can be found in, e.g., U.S. Pat. Nos. 9,616,557, 7,950,312, 7,424,840, 7,401,659, 7,231,854, 7,165,481, 7,121,174, 8,869,656, 6,904,834, 6,109,144, 8,240,232, and 6,073,523, each of which is incorporated by reference in its entirety. In the illustrated example, the fasteners 26 are screws or drywall screws that may be driven into a workpiece by the screwdriving bit 15. When the screwdriving bit 15 engages a fastener 26, the fastener 26 breaks free from the fastener holder 24 so that the fastener 26 can be driven into a workpiece. As mentioned above, in other examples, the fastener strip 20 may include other types of fasteners 26 such as, for example, a nail, a bolt, an anchor, a rivet, or the like, for use with a power tool configured to drive a particular type of fastener into a workpiece.

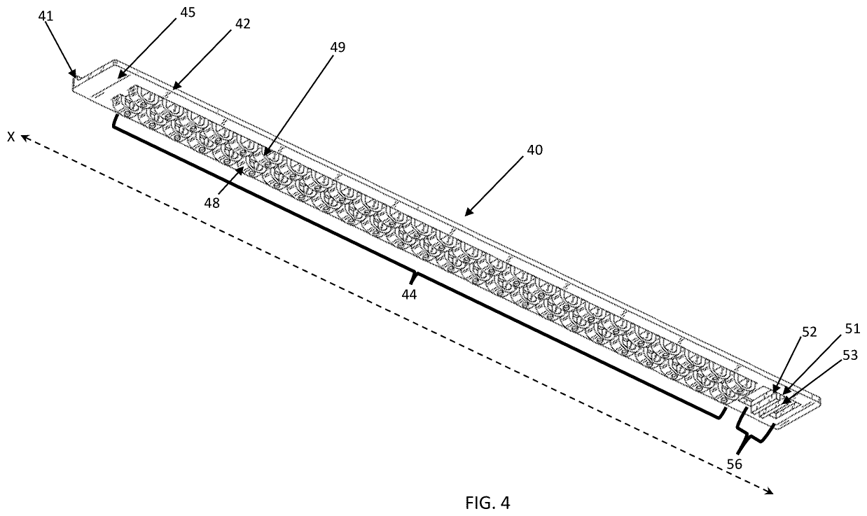

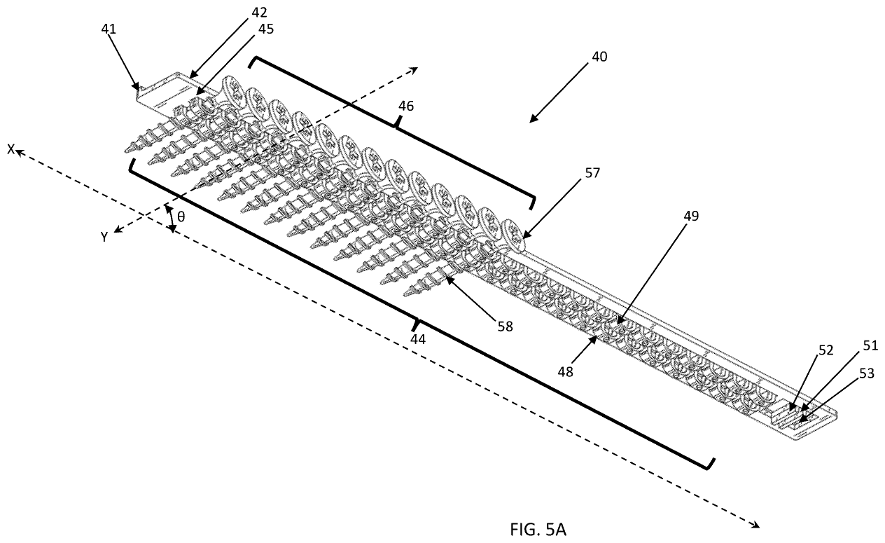

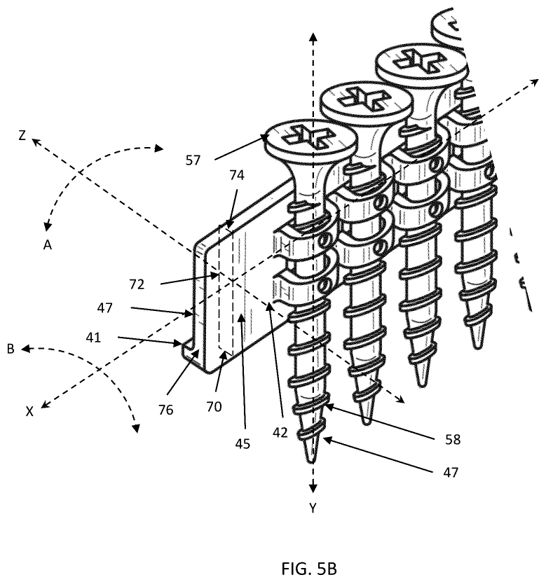

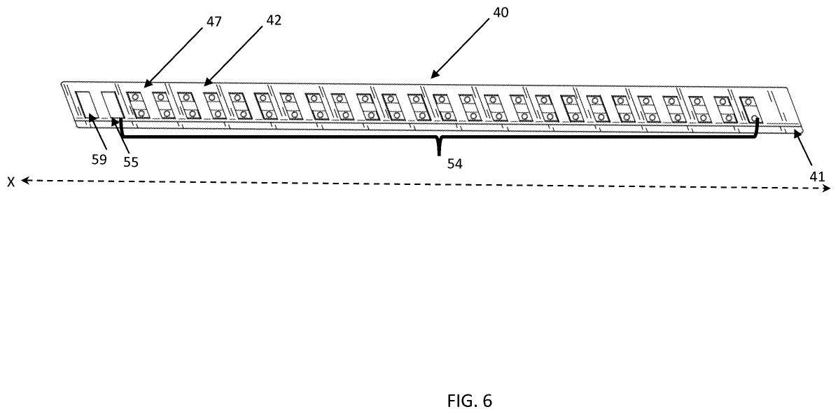

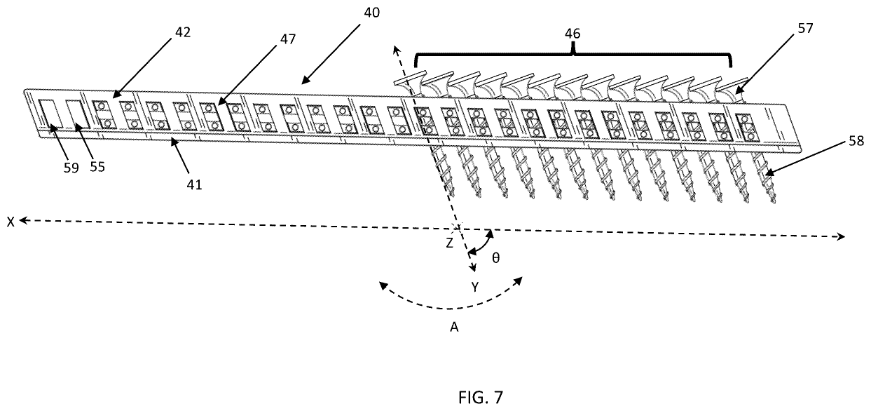

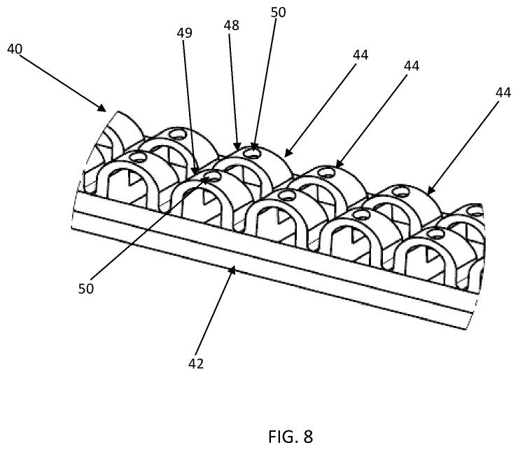

Referring to FIGS. 4-8, FIG. 4 is a perspective view of an example fastener strip 40. FIG. 5A is a perspective view of the fastener strip 40 of FIG. 4 with fasteners 46. FIG. 5B is a close-up perspective view of an end portion of the fastener strip 40 of FIG. 4 with fasteners 46. FIG. 6 is a bottom view of the fastener strip 40 of FIG. 4. FIG. 7 is a bottom view of the fastener strip 40 of FIG. 4 with fasteners 46. FIG. 8 is a partial, detailed perspective view of the fastener strip 40 of FIG. 4. The fastener strip 40 includes the features and functions of the fastener strip 20 of FIGS. 1-3. The fastener strip 40 is intended to be received by the magazine 12 and fed through the feeding and advancing mechanism 14 of the screwgun 10 of FIGS. 1-3. The fastener strip 40 is described in more detail below.

The fastener strip 40 includes a backer 42 and fastener holders 44. The backer 42 extends along a strip axis X (which coincides with the feed direction) and includes a first side 45 and a second side 47, where the first side 45 is opposite the second side 47. The fastener holders 44 are disposed along a length of the first side 45 of the backer 42. The fastener holders 44 are configured to hold fasteners 46 to the backer 42. The backer 42 is configured to be fed through a magazine (e.g., the magazine 12 of FIG. 1) of a power tool (e.g., the screwgun 10 of FIG. 1) such that the fasteners 46 held by the fastener holders 44 may be driven into a workpiece by the power tool (e.g., the screwgun 10 of FIG. 1).

Each of the fastener holders 44 includes a first loop 48 and a second loop 49, which may best be seen in the detail view of FIG. 8. In some examples, the first loop 48 and the second loop 49 may be referred to as a pair of loops. The first loop 48 and the second loop 49 may be semi-circular or semi-oval in shape such that the top of each of the first loop 48 and the second loop 49 is rounded. In other examples, fastener holders may comprise a single loop or more than two loops (e.g., three or more loops).

The first loop 48 includes a hole 50 and the second loop includes a hole 50. The hole 50 also may create a weakness or thinner portion of the loop. The holes 50 aid in enabling the fasteners 46 to break away from the first loop 48 and the second loop 49 as the fasteners 46 are being driven by the power tool into a workpiece. As the fasteners 46 are driven into the workpiece, the holes 50 cause the first loop 48 and the second loop 49 to break away from the backer 42 such that the fasteners 46 are released from the backer 42. In the illustrated example, the hole 50 is a through hole. In other examples, the hole 50 may not be a through hole, but may be a partial hole or a blind hole, a recess, or a score that creates a weakened area enabling the fasteners to break away from the loops when driven by the power tool into a workpiece.

In some examples, the fastener holders 44 may be evenly spaced along the length of the first side 45 of the backer 42. There may be a same amount of space along the backer 42 between each of the fastener holders 44. In some examples, each of the fastener holders 44 may include a fastener 46. In other examples, a subset of the fastener holders 44 may include a fastener 46 such that one or more of the fastener holders 44 may not include a fastener 46 and may be empty.

Each of the fasteners 46 includes a head 57 and a shank 58 coupled to the head 57, as best seen in FIGS. 5A, 5B, and 7. The shank 58 of each of the fasteners 46 is disposed within the first loop 48 and the second loop 49 of each of the fastener holders 44. As discussed above, in some examples, the fasteners 46 are screws having threads, where the screws may be, for instance, drywall screws. In some examples, the head 57 of one of the fasteners 46 overlaps the head 57 of another of the fasteners 46, as seen in FIGS. 5 and 7. The shanks 58 of the fasteners extend along a fastener axis Y in a direction that the fasteners are driven into the workpiece. The fastener axis Y is transverse to the strip axis X.

The backer 42 may be a rigid or a semi-rigid structure that maintains its rigidity as the fastener strip 40 is fed through the feeding and advancing mechanism. In other words, the backer 42 and the projection 41 are not flimsy and are resistant to being bent as the fastener strip 40 is fed through the feeding and advancing mechanism. The backer 42 has a generally rectangular or parallelogram shaped cross-section 70 with a long edge 72 extending generally parallel to the axis Y of the fasteners 47 and a short edge 74 extending between the first side 45 and the second side 47 of the backer 42 along an axis Z that is transverse (e.g., perpendicular) to the axis X. This creates a beam-like shape that resists bending along the axis or feed direction X of the strip, in the direction of arrow A about the axis Z. This geometry contributes to the strip being rigid or semi-rigid.

The fastener strip 40 also includes a projection 41. The projection 41 runs along an edge of the length of the second side 47 of the backer 42. The projection 41 may be a lip or ledge that may function to assist maintaining the rigidity of the fastener strip 40 as the fastener strip 40 is fed through a power tool. The projection 41 supports the backer 42 and creates an L-shape 76. This L-shape 76 may help improve the rigidity of the backer 42 along the feed direction X, inhibiting bending in the direction of arrow A. The L-shape may also improve rigidity of the strip X about the feed axis X, inhibiting bending in the direction of arrow B. The projection 41 also may be used to assist in aligning the backer 42 for feeding into magazine and the feeding and advancing mechanism. In some examples, the projection may include one or more teeth to assist in guiding the fasteners through the advancing mechanism.

As discussed above, the backer 42 includes recesses 54. The recesses 54 are disposed along the length of the backer 42, as best seen in FIG. 6. Each of the recesses 54 may be aligned with one of the fastener holders 46. The recesses 54 are configured to be engaged by a pawl of the power tool (e.g., pawls 30a and 30b of screwgun 10 of FIG. 3) as the backer 42 is fed through the magazine of the power tool (e.g., magazine 12 of the screwgun 10 of FIG. 3).

In some examples, the recesses 54 may have a parallelogram shape. In some examples, the recesses 54 may have a rectangular shape. In some examples, the recesses 54 are holes or apertures that provide an opening from the first side 45 of the backer 42 to the second side 47 of the backer 42. In other examples, the recesses 54 may not be apertures that penetrate from one side of the backer 42 through to the other side of the backer 42.

The fastener strip 40 may include a terminal support 51, as best seen in FIGS. 4 and 5. The terminal support 51 may be disposed between one end of the backer 42 and an end recess 55 of the recesses 54, where the end recess 55 is best seen in FIGS. 6 and 7. The terminal support 51 may include a terminal recess 59 that is configured to be engaged by a pawl (e.g., pawl 30a or pawl 30b of FIG. 3) when the fastener 46 in a last one of the fastener holders is being driven by the power tool (e.g., screwgun 10 of FIG. 3).

The terminal support 51 may include a terminal protrusion 56 that projects from the first side 45 of the backer 42. The terminal support 51 may include a first terminal support 52 and a second terminal support 52. The first terminal support 52 and the second terminal support 53 project from the first side 45 of the backer 42.

In some examples, each of the fasteners 46 is received in the fastener holder 44 within the first loop 48 and the second loop 49 along the fastener axis Y that is transverse to the strip axis X, as best seen in FIGS. 5A and 5B. In some examples, the fastener axis Y is at an acute angle θ to the strip axis X. In some examples, the recesses 54 are disposed along the length of the backer 42 with each of the recesses 54 extending along the fastener axis Y. In the illustrated example, the fastener axis Y is at an acute angle θ (e.g., approximately 30° to approximately 89° relative to the strip axis X.) In other examples, the fastener axis Y may be approximately perpendicular to the strip axis X.

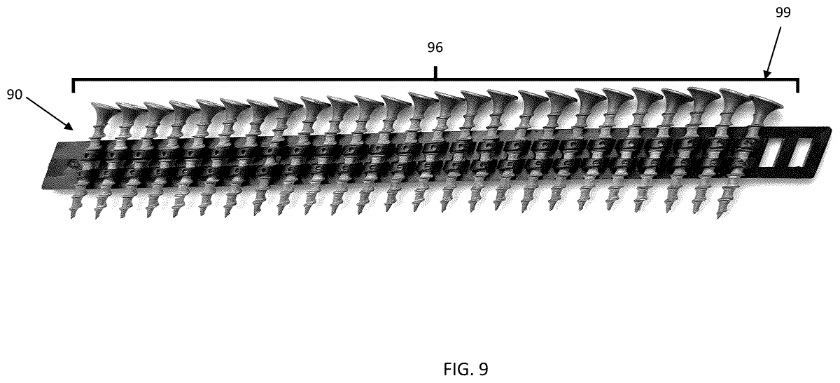

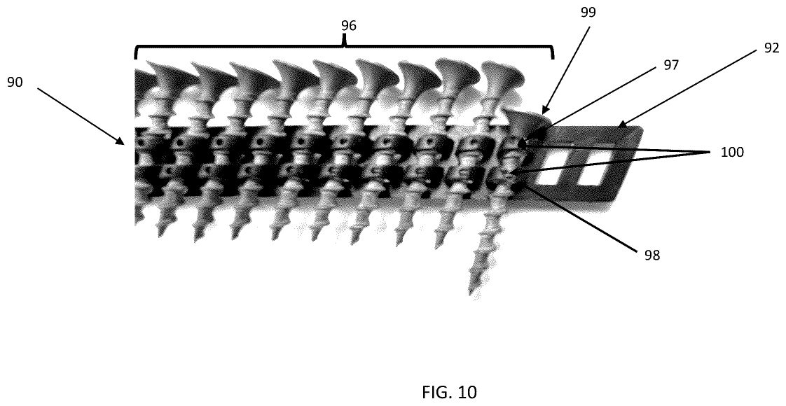

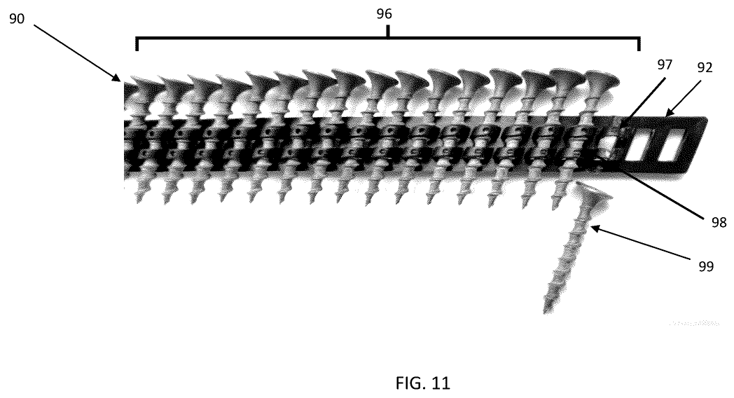

FIGS. 9-11 illustrate a state or position of a fastener relative to the fastener strip in different stages of being driven into a workpiece by a power tool. FIG. 9 is a view of another example fastener strip 90 illustrating fasteners 96 before being driven. FIG. 10 is a detailed view of the fastener strip 90 of FIG. 9 illustrating a position of a fastener 99 as the fastener is being driven. FIG. 11 is a detailed view of the fastener strip 90 of FIGS. 9 and 10 illustrating the position of the fastener 99 of FIG. 10 after the fastener has been driven. The fastener strip 90 may include the same features and functions as the fastener strip 40 of FIGS. 4-8.

In FIG. 9, all of the fasteners 96 are seated within the fastener strip 90, including the fastener 99. As shown in FIG. 10, when driving the fastener 99, the pair of loops including the first loop 97 and the second loop 98 break at the holes 100, allowing the fastener 99 to be released from the backer 92. As shown in FIG. 11, the head of the fastener 99 passes through the broken loops 97 and 98, allowing the fastener 99 to be driven into a workpiece.

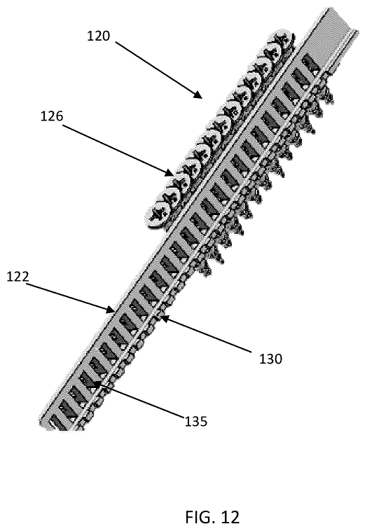

FIG. 12 is a rear, perspective view of another example fastener strip 120 with fasteners 126. The fastener strip 120 includes the same or similar features and functions as the fastener strip 40 of FIGS. 4-8. One difference between the fastener strip 120 and the fastener strip 40 is that the fastener strip 120 includes a multiple teeth along the projection 130. The teeth along the length of the projection 130 may be used to assist in feeding the fastener strip 120 in the magazine and the feeding and advancing mechanism of the power tool. In this example fastener strip 120, the recesses 135 in the backer 122 are rectangular in shape.

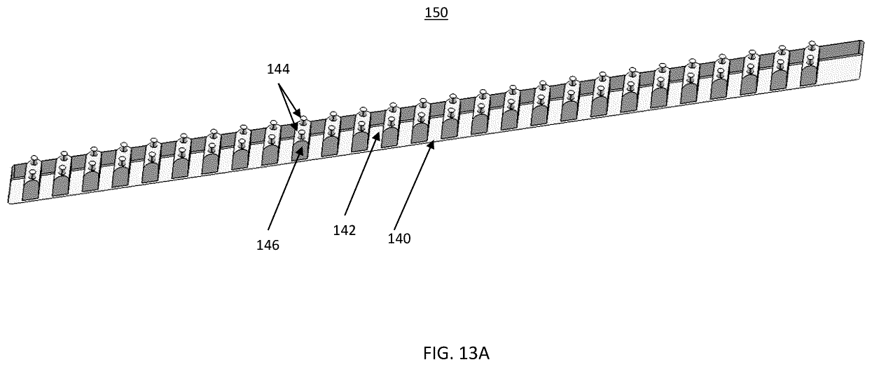

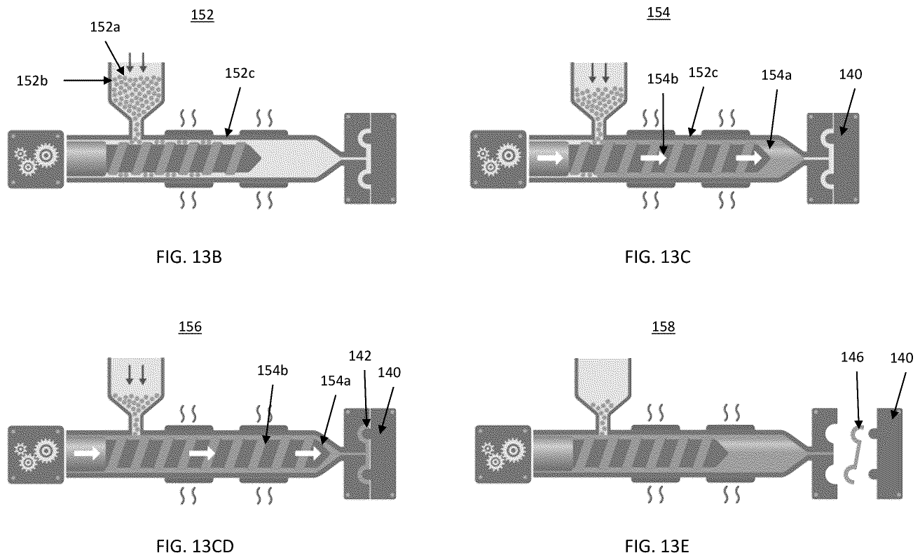

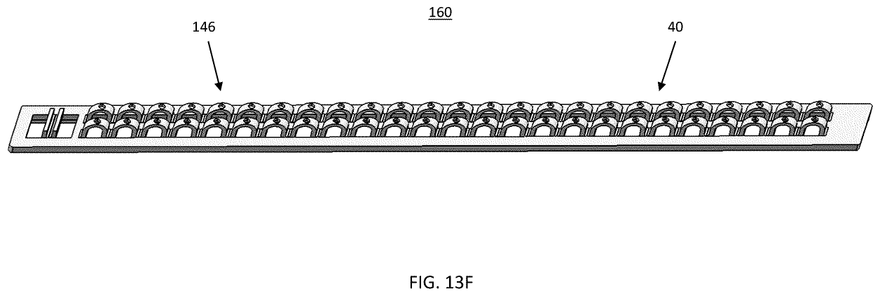

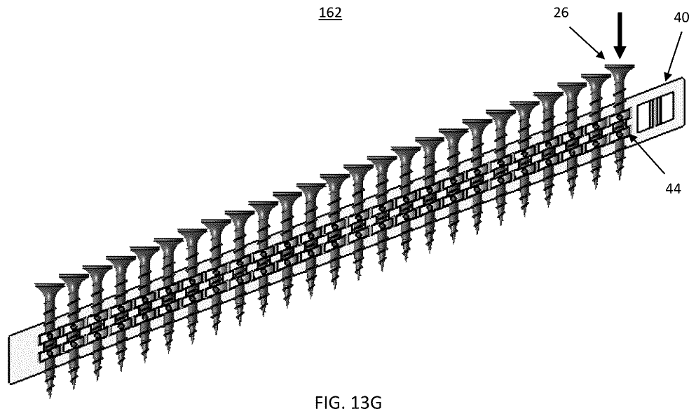

FIGS. 13A-13G schematically illustrate an example process for manufacturing a fastener strip, e.g., by molding or injection molding. As shown in FIG. 13A, at step 150, a mold 140 is manufactured and provided. The mold 140 has a mold cavity 142 having an inverse shape of the fastener strip to be manufactured. Core pins 144 are provided in the mold cavity in the portions 146 that form the first and second loops to form a first hole in each first loop and a second hole in each second loop. As shown in FIG. 13B, at step 152, plastic granules 152a are fed via a hopper or funnel 152b into a barrel 152c and the granules are heated to a molten state. As shown in FIG. 13C, at step 154, the heated molten plastic 154a fills the barrel 152c and a motorized screw 154b pushes the molten plastic toward the mold 140. As shown in FIG. 13D, at step 156, the screw 154b injects the molten plastic 154a at pressure into the mold cavity via gates and hot runners. As shown in FIG. 13E, at step 158, the plastic product 146 inside the mold 140 is allowed to cool and solidify before the mold 140 is opened and the plastic product 140 is ejected from the opened mold 140. As shown in FIG. 13F, at step 160, the ejected plastic product 146 comprises a fastener strip 40 without fasteners inserted. As shown in FIG. 13G, at step 162, fasteners 26 are pushed into the loops of the fastener holders 44 in the fastener strip 40.

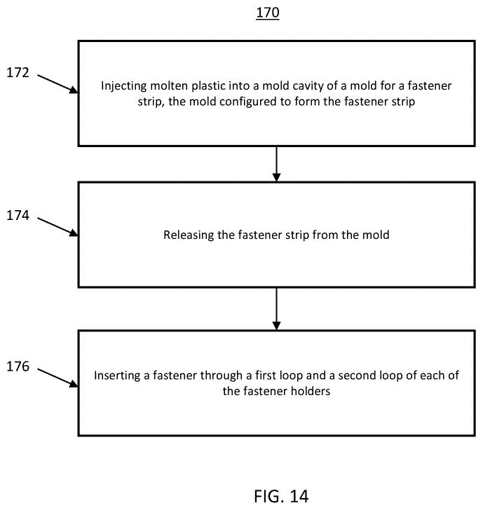

FIG. 14 is an example flow diagram of an injection molding process 170 for manufacturing a fastener strip. Process 170 includes injecting molten plastic into a mold cavity of a mold for a fastener strip, where the mold cavity is configured to form the fastener strip (172). The fastener strip includes a backer extending along a strip axis and having a first side and a second side, where the second side is opposite the first side. Fastener holders are disposed along a length of the first side of the backer, where each of the fastener holders includes a first loop and a second loop. There is a first hole in the first loop and a second hole in the second loop of each of the fastener holders. In other examples, other types of molding, casting, or extruding processes may be used to manufacture the fastener strip.

Process 170 includes releasing the fastener strip from the mold (174). Process 170 includes inserting a fastener through the first loop and the second loop of each of the fastener holders (176).

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A strip for holding fasteners, comprising:
a backer extending along a strip axis and having a first side and a second side, the second side being opposite the first side; and
a plurality of fastener holders disposed along a length of the first side of the backer, wherein each of the plurality of fastener holders includes a first loop having a first hole and a second loop having a second hole configured to hold a fastener,
wherein the backer is configured to be fed through a magazine of a power tool such that a plurality of fasteners held by the plurality of fastener holders may be driven into a workpiece by the power tool.

2. The strip of claim 1, wherein the plurality of fasteners are disposed within at least a subset of the plurality of fastener holders, wherein each of the plurality of fasteners is disposed within one of the subset of the plurality of fastener holders.

3. The strip of claim 2, wherein each of the plurality of fasteners comprises a shank and the plurality of fastener holders are configured such that the shank of each of the plurality of fasteners is disposed within the first loop and the second loop of one of the subset of the plurality of fastener holders.

4. The strip of claim 3, wherein each of the plurality of fasteners comprises a head and the plurality of fastener holders are configured such that a head of a first fastener of the plurality of fasteners overlaps a head of a second fastener of the plurality of fasteners.

5. The strip of claim 1, further comprising a projection along an edge of a length of the second side of the backer.

6. The strip of claim 5, wherein the projection includes a plurality of teeth along a length of the projection.

7. The strip of claim 1, wherein the backer includes a plurality of recesses disposed along the length of the backer with each of the plurality of recesses aligned with one of the plurality of fastener holders, wherein the plurality of recesses are configured to be engaged by a feeding device of the power tool as the backer is fed through the magazine.

8. The strip of claim 7, further comprising a terminal support disposed between one end of the backer and an end recess of the plurality of recesses.

9. The strip of claim 8, wherein the terminal support comprises a terminal recess configured to be engaged by a feeding device of the power tool when the fastener in a last one of the plurality of fastener holders is being driven by the power tool.

10. The strip of claim 9, wherein the terminal support further comprises a terminal protrusion that projects from the first side of the backer adjacent the terminal recess.

11. The strip of claim 1, wherein each of the plurality of fasteners is received in each of the first loop and the second loop of the plurality of fastener holders along a fastener axis that is transverse to the strip axis.

12. The strip of claim 11, wherein the fastener axis is at an acute angle to the strip axis.

13. The strip of claim 1, wherein the first hole and the second hole each comprises a through hole, a partial hole, a blind hole, a recess, or a score.

14. A strip for holding fasteners, comprising:
a backer extending along a strip axis and having a first side and a second side, the second side being opposite the first side;
a plurality of fastener holders disposed along a length of the first side of the backer; and
a terminal support that projects from the first side of the backer disposed between one end of the backer and an end fastener holder from the plurality of fastener holders.

15. The strip of claim 14, wherein the terminal support includes a first terminal support and a second terminal support.

16. The strip of claim 15, wherein the terminal support comprises a terminal recess configured to be engaged by a pawl when a fastener in a last one of the plurality of fastener holders is being driven by a power tool.

17. The strip of claim 16, wherein the terminal support further comprises a terminal protrusion that projects from the first side of the backer adjacent the terminal recess.

18. The strip of claim 18, wherein each of the fasteners is received in one of the plurality of fastener holders along a fastener axis that is transverse to the strip axis.

19. The strip of claim 18, wherein the fastener axis is at an acute angle to the strip axis.

20. A method of manufacturing a fastener strip, the method comprising:
injecting molten plastic into a mold cavity of a mold for a fastener strip, the mold configured to form the fastener strip including
a backer extending along a strip axis and having a first side and a second side, the second side being opposite the first side,
a plurality of fastener holders disposed along a length of the first side of the backer, wherein each of the plurality of fastener holders includes a first loop and a second loop, and
a first hole in the first loop and second hole in the second loop of each of the plurality of fastener holders;
releasing the fastener strip from the mold; and
inserting a fastener through the first loop and the second loop of each of the plurality of fastener holders.
